(19) United States
(12) Patent Application Publication
(10) Pub. No.: US 2014/0104490 A1
(43) Pub. Date: Apr. 17, 2014

(54) IMAGE CAPTURE DEVICE

(71) Applicants: Tsung-Yen Hsieh, Taichung City (TW); Chia-Hsiung Chang, Tainan City (TW)

(72) Inventors: Tsung-Yen Hsieh, Taichung City (TW); Chia-Hsiung Chang, Tainan City (TW)

(73) Assignees: WINTEK CORPORATION, Taichung City (TW); DONGGUAN MASSTOP LIQUID CRYSTAL DISPLAY CO., LTD., Guangdong Province (CN)

(21) Appl. No.: 14/051,462

(22) Filed: Oct. 11, 2013

(30) Foreign Application Priority Data
Oct. 12, 2012 (TW) 101137775

(51) Int. Cl. H04N 5/225

(52) U.S. Cl. CPC H04N 5/2252
USPC 348/375

(57) ABSTRACT

An image capture device including a housing, a first lens unit, a second lens unit, an image sensing element, and a beam spliter is provided. The housing includes a body, a first lens barrel, and a second lens barrel. The first lens unit is disposed within the first lens barrel and includes a first switchable light valve. The second lens unit is disposed within the second lens barrel and includes a second switchable light valve. The image sensing element faces to the first lens unit. The beam spliter is configured in front of the image sensing element so that the image sensing element is able to receive a first image light passing through the first lens unit and a second image light passing through the second lens unit. The first switchable light valve and the second switchable light valve present a transparent state at different timings.

### CROSS-REFERENCE TO RELATED APPLICATION

This application claims the priority benefit of Taiwan application serial no. 101137775, filed on Oct. 12, 2012. The entirety of the above-mentioned patent application is hereby incorporated by reference herein and made a part of this specification.

### BACKGROUND OF THE INVENTION

1. Field of the Invention

The present invention generally relates to an image capture device, in particular, to a multi-view image capture device.

2. Description of Related Art

A conventional in-vehicle video recorder including a single lens module is only able to take the image within a partial field of view and fails to record a situation of surroundings in an accident. Therefore, double lenses are disposed within some new in-vehicle video recorders so as to increase a filming field of view. However, such in-vehicle video recorders are manufactured by a combination of two image capture devices, which are not able to effectively reduce an overall volume thereof.

This is definitely also a problem that other image capture devices to achieve multi-view image capture are dealing with.

### SUMMARY OF THE INVENTION

The present invention is directed to an image capture device, which is able to capture an image with multiple views and has a simple structure.

The present invention is directed to an image capture device, includes a housing, a first lens unit, a second lens unit, an image sensing element, and a beam spliter. The housing includes a body, a first lens barrel, and a second lens barrel. The first lens barrel and the second lens barrel are inter-connected with the body. The first lens unit is disposed within the first lens barrel of the housing, wherein the first lens unit includes a first switchable light valve so as to allow a first image light to pass through the first lens unit. The second lens unit is disposed within the second lens barrel of the housing, wherein the second lens unit includes a second switchable light valve so as to allow a second image light to pass through the second lens unit. The image sensing element is disposed within the body. The beam spliter is disposed on a light path of the first image light. The beam spliter is also disposed on a light path of the second image light so as to allow the image sensing element to receive the first image light and the second image light. The first switchable light valve and the second switchable light valve present a transparent state at different timings.

According to an embodiment of the present invention, the beam spliter is disposed between the first lens unit and the image sensing element.

According to an embodiment of the present invention, the image sensing element faces towards to the first lens unit.

According to an embodiment of the present invention, the first lens barrel and the second lens barrel have different extended directions so as to allow the first lens unit and the second lens unit to face towards different directions.

According to an embodiment of the present invention, the first lens unit further includes at least one lens, wherein the at least one lens is disposed on a side of the first switchable light valve.

According to an embodiment of the present invention, the second lens unit further includes at least one lens, wherein the at least one lens is disposed on a side of the second switchable light valve.

According to an embodiment of the present invention, each of the first switchable light valve and the second switchable light valve individually includes a liquid crystal unit and two polarizers disposed on two opposite sides of the liquid crystal unit.

According to an embodiment of the present invention, the first lens barrel and the second lens barrel mutually overlap in a direction, and the housing further includes a rotating mechanism, wherein the rotating mechanism is disposed between the first lens barrel and the second lens barrel so as to allow at least one of the first lens barrel and the seconds barrel to suitably rotate on a plane perpendicular to the direction. Extended directions of the first lens barrel and the second lens barrel are different so as to allow the first lens unit and the second lens unit to face towards different directions.

According to an embodiment of the present invention, the image capture device further includes a light path adjusting element disposed on a side of the second lens unit so as to adjust a path of the second image light and allow the second image light to pass towards the beam spliter. The light path adjusting element is, for example, a reflector or a prism.

According to an embodiment of the present invention, the image capture device further includes a third lens unit and the housing further includes a third lens barrel. The third lens unit is disposed within the third lens barrel, wherein the third lens unit includes a third switchable light valve so as to allow a third image light to pass through the third lens unit. Each of the first switchable light valve, the second switchable light valve, and the third switchable light valve individually presents a transparent state at a different timing so as to allow the image sensing element to receive the first image light, the second image light, and the third image light at different timings. The third lens unit further includes at least one lens disposed on a side of the third switchable light valve. Moreover, the third switchable light valve includes a liquid crystal unit and two polarizers disposed on two opposite sides of the liquid crystal unit. For example, the first lens barrel, the second lens barrel, and the third lens barrel respectively extend to different directions so as to allow the first lens unit, the second lens unit, and the third lens unit to face towards different directions. The second lens barrel and the third lens barrel may substantially be disposed on two opposite sides of the first lens barrel. Alternatively, the second lens barrel and the third lens barrel may substantially be disposed on two adjacent sides of the first lens barrel. Meanwhile, the housing may further include a rotating mechanism, wherein the rotating mechanism is disposed between the first lens barrel and the second lens barrel so as to allow the second lens barrel to suitably rotate on a side of the first lens barrel.

Based on the above descriptions, a beam splitter is disposed between two lens units, and timings of different image lights passing into an image capture device are controlled by switchable light valves within the lens units in the embodiments of the present invention. Hence, only one image sensing element is required to be disposed within the image capture device in the embodiments of the present invention without a substantial increment of an overall volume. Additionally, the two lens units in the embodiments of the present invention may be disposed to be facing towards different directions so as to capture the images of multiple views and enhance a usage convenience of the image capture device.

In order to make the aforementioned and other objects, features and advantages of this invention comprehensible, a preferred embodiment accompanied with figures is described in detail below.

### BRIEF DESCRIPTION OF THE DRAWINGS

FIG. 1 is a schematic diagram of an image capture device in accordance with a first embodiment of the present invention.

FIG. 2 is a schematic diagram of a first lens barrel and a second lens barrel of the image capture device in FIG. 1.

FIG. 3A is a schematic diagram of an image capture device in accordance with a second embodiment of the present invention.

FIG. 3B is a schematic diagram of the first lens barrel and the second lens barrel of the image capture device in FIG. 3A.

FIG. 4 is a schematic diagram of an image capture device in accordance with a third embodiment of the present invention.

FIG. 5 is a schematic diagram of an image capture device in accordance with a fourth embodiment of the present invention.

FIG. 6 is a schematic diagram of an image capture device in accordance with a fifth embodiment of the present invention.

FIG. 7 schematically shows the first lens barrel and the second lens barrel of the image capture device in the fifth embodiment of the present invention after rotation.

FIG. 8 is a schematic diagram of a housing of an image capture device in accordance with a sixth embodiment of the present invention.

FIG. 9 schematically shows the image capture device in the sixth embodiment of the present invention after rotation of the second lens barrel.

### DESCRIPTION OF THE EMBODIMENTS

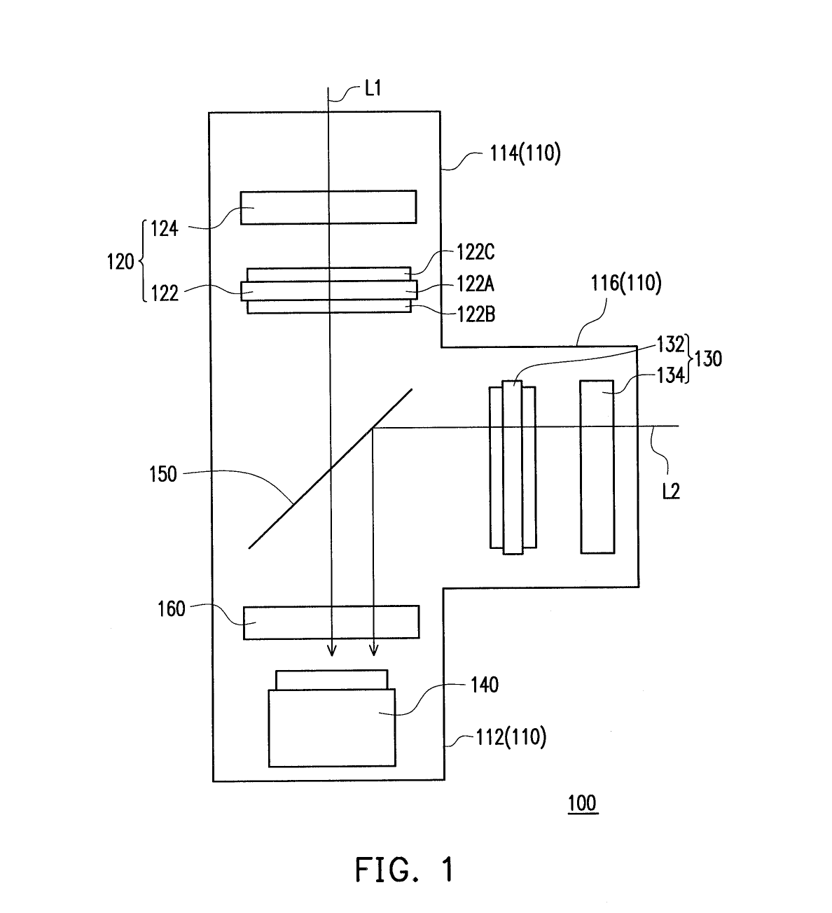

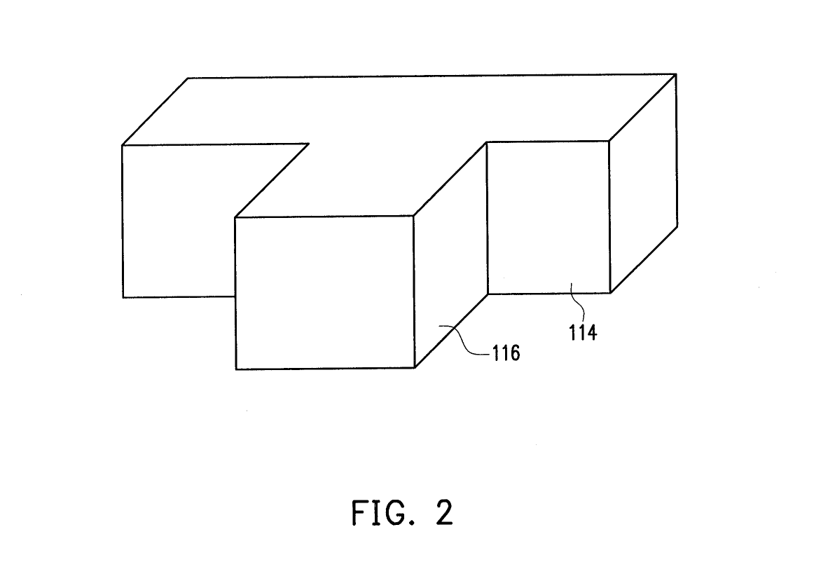

FIG. 1 is a schematic diagram of an image capture device in accordance with a first embodiment of the present invention. FIG. 2 is a schematic diagram of a first lens barrel and a second lens barrel of the image capture device in FIG. 1. Referring to both FIG. 1 and FIG. 2, an image capture device 100 includes a housing 110, a first lens unit 120, a second lens unit 130, an image sensing element 140, a beam spliter 150, and at least one lens 160. The housing 110 includes a body 112, a first lens barrel 114, and a second lens barrel 116. The first lens barrel 114 and the second lens barrel 116 are inter-connected with the body 112. The first lens unit 120 is disposed within the first lens barrel 114 of the housing 110. The second lens unit 130 is disposed within the second lens barrel 116 of the housing 110. The image sensing element 140 is disposed within the body 112. The beam spliter 150 is configured on a light path of a light, in which light will be expectedly received by the image sensing element 140. Also, the lens 160 may be selectively disposed between the beam spliter 150 and the image sensing element 140. In other embodiments, the lens 160 may not require to be disposed therebetween.

The body 112, the first lens barrel 114, and the second lens barrel 116 are all in a hollow barrel-shaped structure, wherein a space of the first lens 114 and that of the second lens 116 are connected within the body 112. That is, the body 112, the first lens barrel 114, and the second lens barrel 116 jointly form an inter-connected space. Additionally, an extended direction of the first lens barrel 114, for example, intersects (perpendicularly) an extended direction of the second lens barrel 116. Meanwhile, filming directions of the first lens unit 120 and the second lens unit 130 may be mutually perpendicular. However, the housing 110 in FIG. 1 and FIG. 2 is only illustrated as an example. In other embodiments, an appearance of the housing 110 may be changed based on different requirements. For example, the extended direction of the first lens barrel 114 may not require to perpendicular to that of the second lens barrel 116.

Regarding the present embodiment, the first lens unit 120 includes a first switchable light valve 122 and at least one lens 124, wherein the first switchable light valve 122 may present a transparent state and a non-transparent state. When the first switchable light valve 122 presents the transparent state, a first image light L1 may pass through the first lens unit 120 so that the image sensing element 140 is able to receive the first image light L1 so as to achieve an image capture function. The lens 124 herein may adjust an incident angle of the first image light L1, which is advantageous for the first lens unit 120 to possess different dimensions of views. Disposed on a side close to an outside of the image capture device 100, the lens 124 adjacent to the first switchable light valve 122 (as illustrated in FIG. 1) may focus the first image light L1 onto a smaller area. Therefore, an area of the first switchable light valve 122 may accordingly decrease. However, in other embodiments, the lens 124 may also be selectively disposed between the first switchable light valve 122 and the image sensing element 140, and only provide an adjustment to the light after the first image light L1 passes through the first switchable light valve 122.

The first switchable light valve 122 may include a liquid crystal unit 122A, a polarizer 122B and a polarizer 122C, wherein the polarizer 122B and the polarizer 122C are disposed on two opposite sides of the liquid crystal unit 122A. The liquid crystal unit 122A includes a plurality of liquid crystal molecules, and the polarizer 122B and the polarizer 122C may have a same polarization state or different polarization states.

However, the present embodiment is not limited thereto. In other embodiments, the first switchable light valve 122 may be other elements such as a mechanical shutter.

Additionally, the second lens unit 130 includes a second switchable light valve 132 and at least one lens 134 disposed on a side of the second switchable light valve 132. When the second switchable light valve 132 presents the transparent state, a second image light L2 may pass through the second lens unit 130. The beam spliter 150 herein is, for example, :positioned on a light path of the second image light L2 so that the image sensing element 140 is able to receive the second image light L2. Functionalities and compositions of the switchable light valve 132 and the lens 134 may refer to the descriptions of the first lens unit 120 and will not be additionally described.

Noteworthily, each of the first lens barrel 114 and the second lens barrel 116 of the housing 110 possess different extended directions respectively, wherein the extended directions thereof may be mutually perpendicular. Therefore, the first lens unit 120 and the second lens unit 130 face to different directions individually so as to capture images from different views. Hence, the first image light L1 and the second image light L2 come from different viewing directions such that the image capture device 100 may capture an image in a wider view so as to achieve a super wide-angle image capture effect.

The image sensing element 140 herein is, for example, a charge coupled device (CCD), and yet it may selectively be a contact image sensor (CIS) or other elements capable of sensing images. Additionally, the image capture device 100 in the present embodiment may receive the first image light L1 and the second image light L2 from different view angle directions by using the same image sensing element 140. When the image sensing element 140 faces to the first lens unit 120, the beam spliter 150 is, for example, disposed between the first lens unit 120 and the image sensing element 140 so as to allow the second image light L2 to emit towards the image sensing element 140.

The number of the image sensing element 140 does not require to be adjusted by the number of the lens units in the image capture device 100, and therefore an overall volume thereof may not substantially increase. Additionally, since the number of the image sensing element 140 does not require to be adjusted by the number of the lens units in the image capture device 100, connecting wires or related connecting components do not require to be configured to connect multiple image sensing elements so that the design of the image capture device 100 is advantageously simplified.

In order to prevent mutual interference between the first image light L1 and the second image light L2, the first switchable light valve 122 and the second switchable light valve 132 present the transparent state at different timings from each other in the present embodiment. That is, when the image capture device 100 captures an image, the first switchable light valve 122 and the second switchable light valve 132 may present the transparent state alternately, but not simultaneously. In other words, the first image light L1 and the second image light L2 may be received by the image sensing element 140 alternately so as to obtain two images with high definition.

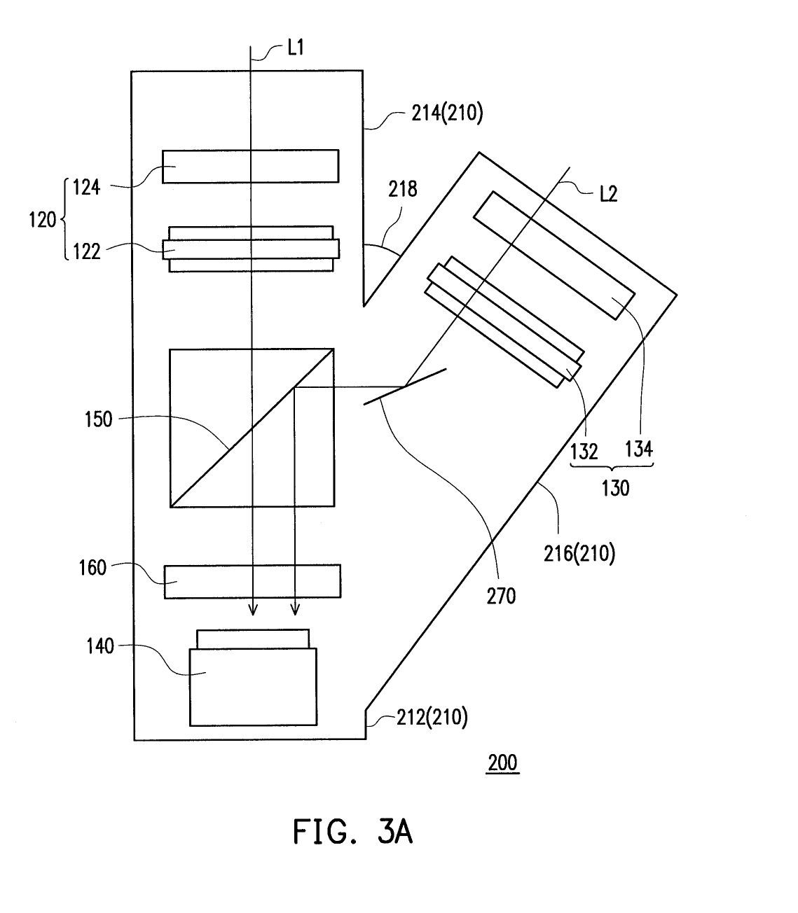

The image capture device 100 as hereinbefore is described in a viewpoint of the mutually perpendicular extended directions of the first lens barrel 114 and the second lens barrel 116, and yet the present invention is not limited thereto. For example, FIG. 3A is a schematic diagram of the image capture device in accordance with a second embodiment of the present invention, and FIG. 3B is a schematic diagram of the first lens barrel and the second lens barrel of the image capture device in FIG. 3A.

Referring to both FIG. 3A and FIG. 3B, an image capture device 200 includes a housing 210, a first lens unit 120, a second lens unit 130, an image sensing element 140, a beam spliter 150, at least one lens 160, and a light path adjusting element 270. Concretely speaking, differences between the present embodiment and the first embodiment are mainly from an appearance design of the housing 210 and an arrangement of the light path adjusting element 270. Therefore, structures and arrangement relations of other components may refer to the related descriptions in the first embodiment.

In the present embodiment, the housing 210 includes a body 212, a first lens barrel 214, and a second lens barrel 216, wherein the first lens barrel 214 and the second lens barrel 216 are both inter-connected with the body 212 so as to form an inner connected space. The components such as the first lens unit 120, the second lens unit 130, and the image sensing element 140 are all disposed within such inner connected space. Additionally, an angle 218 between the extended directions of the first lens barrel 214 and the second lens barrel 216, for example, is not equal to 90 degrees. That is, an extended direction of the first lens barrel 214 is not perpendicular to that of the second lens barrel 216. Hence, the range of the angle of the view constructed by the first image light L1 and the second image light L2 may be different from that in the first embodiment.

Additionally, in the present embodiment, in order to adjust the light path of the second image light L2 so that the second image light L2 may be received by the image sensing element 140 via an effect of the beam spliter 150, the light path adjusting element 260 may be disposed on a side of the second lens unit 130. The light path adjusting element 270 herein may be a reflector or a prism, which is used to change a travelling direction of the second image light L2 so that the second image light L2 may be able to pass towards the image sensing element 140 after it is incident onto the beam spliter 150. The prism may include a triangular prism, a pentagonal prism, etc. Noteworthily, in other embodiments, the second image light L2 may be incident onto the beam spliter 150 based on a suitable incident angle without an effect of the light path adjusting element 270, and subsequently, when it passes towards the image sensing element 140, the light path adjusting element 270 may be selectively omitted in the image capture device 200 so as to simplify an overall structure.

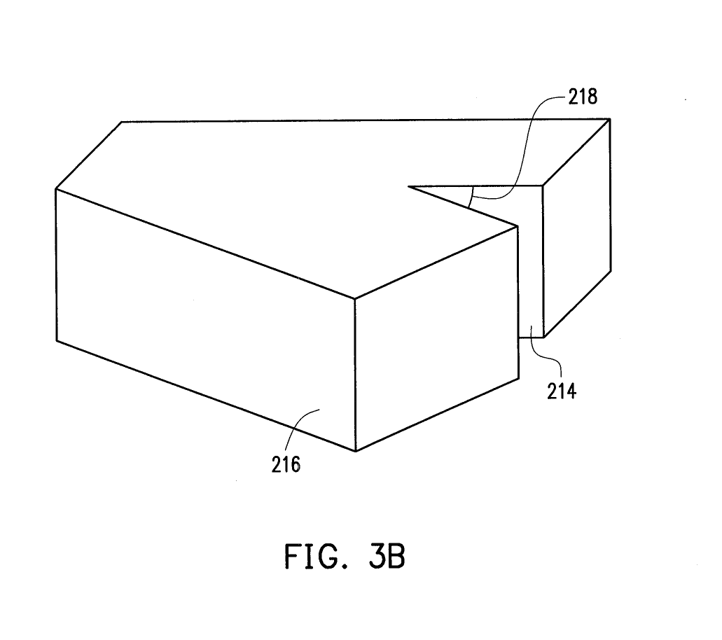

FIG. 4 is a schematic diagram of an image capture device in accordance with a third embodiment of the present invention. Referring to FIG. 4, an image capture device 200A includes a housing 210, a first lens unit 120, a second lens unit 130, an image sensing element 140, a beam spliter element 250, and at least one lens 160. Concretely speaking, a difference between the present embodiment and the second embodiment is mainly that an angle 218 between the extended directions of the first lens barrel 214 and the second lens barrel 216 is, for example, greater than 90 degrees, and an arrangement of the beam spliter 250 is different from that in the second embodiment. Therefore, structures and arrangement relations of other components may refer to the related descriptions in the second embodiment.

In the present embodiment, the angle 218 between the extended directions of the first lens barrel 214 and the second lens barrel 216 may be about 180 degrees, and yet in other embodiments, the angle 218 may be 120 degrees, 150 degrees or fall in a range between 90 and 180 degrees. Hence, the first image light L1 and the second image light L2 are incident onto the image capture device 200A from approximately opposite directions. Meanwhile, in order to allow the first image light L1 and the second image light L2 emit towards the image sensing element 140, the beam spliter 250 may be disposed on light paths of the first image light L1 and the second image light L2. Additionally, in the present embodiment, a light path adjusting element may be selectively disposed in the image capture device 200A so as to adjust incident angles of the first image light L1 and the second image light L2 onto the beam spliter element 250 so that the first image light L1 and the second image light L2 may be received by the image sensing element 140.

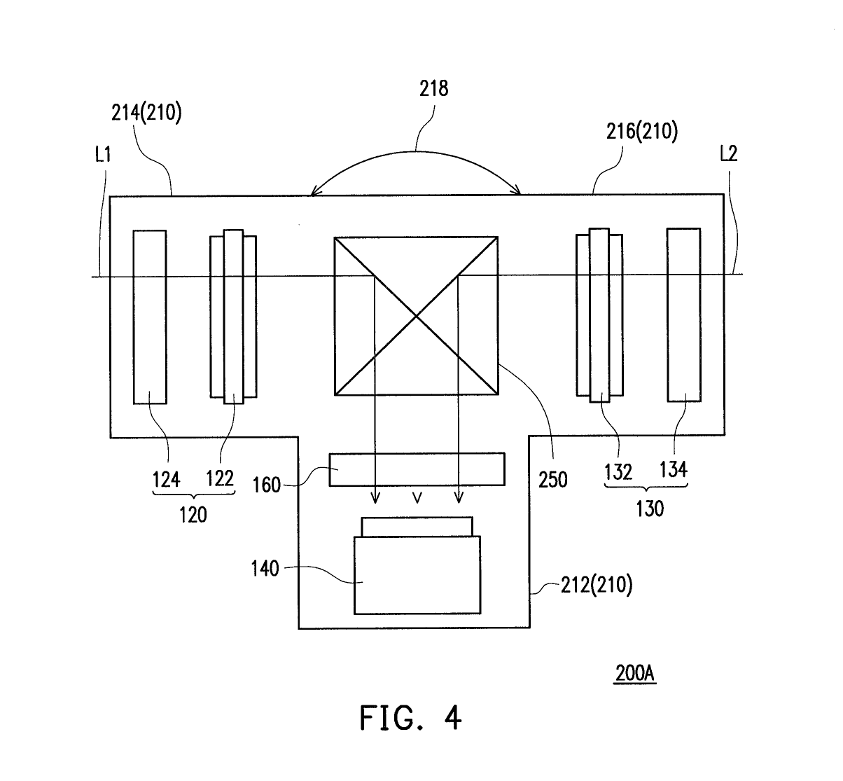

FIG. 5 is a schematic diagram of the image capture device in accordance with a fourth embodiment of the present invention. Referring to FIG. 5, an image capture device 300 substantially includes a housing 310, a first lens unit 320, a second lens unit 330, a third lens unit 340, an image sensing element 350, a beam spliter 360, and at least one lens 370. The housing 310 includes a body 312, a first lens barrel 314, a second lens barrel 316, and a third lens barrel 318. The first lens barrel 314, the second lens barrel 316, and the third lens barrel 316 are all inter-connected with the body 312. The first lens unit 320 is disposed within the first lens barrel 314 of the housing 310. The second lens unit 330 is disposed within the second lens barrel 316 of the housing 310. The third lens unit 340 is disposed within the third lens barrel 318 of the housing 310. The image sensing element 350 is disposed within the body 312. When the image sensing element 350 faces towards the first lens unit 320, the beam spliter is, for example, disposed between the first lens unit 320 and the image sensing element 350, and yet the present invention is not limited thereto. Also, the lens 370 may be selectively disposed between the beam spliter 360 and the image sensing element 350. In other embodiments, the lens 370 may not require to be disposed therebetween.

Concretely speaking, an extended direction of the first lens barrel 314 may intersect that of the second lens barrel 316, and an extended direction of the third lens barrel 318 may also intersect that of the first lens barrel 314. Also, the second lens barrel 316 and the third lens barrel 318 may substantially be disposed on two opposite sides of the first lens barrel 314. Additionally, the first lens unit 320 includes a switchable light valve 322 and at least one lens 324. The second lens unit 330 includes a second switchable light valve 332 and at least one lens 334. The third lens unit 340 includes a third switchable light valve 342 and at least one lens 344. Therefore, the image capture device 300 includes the three lens units disposed within the first lens barrel 314, the second lens barrel 316, and the third lens barrel 318 respectively having different extended directions, so as to capture images in different directions and achieve a wide-angle image capture effect.

In the present embodiment, the first image light L1, the second image light L2, and the third image light L2 from different directions passes into the image capture device 300 via the first lens unit 320, the second lens unit 330, and the third lens unit 340 respectively. Meanwhile, in order to allow the second image light L2 and the third image light L3 to be incident towards the only image sensing element 350, the beam spliter 360 may be a X-cube dichroic prism. Hence, the image capture device 300 may possess a super wide-angle image capture effect. Meanwhile, in order to prevent mutual interference among the first image light L1, the second image light L2, and the third image light L3 from different directions, the first switchable light valve 322, the second switchable light valve 332, and the third switchable light valve 342 may present the transparent state at different timings from one another. That is, the design of the present embodiment may allow the first image light L1, the second image light L2, and the third image light L3 to be received by the image sensing element 350 via alternations among the first switchable light valve 322, the second switchable light valve 332, and the third switchable light valve 342 so as to obtain high definition images from different angles.

A single image sensing element 350 is used in the image capture device 300 to capture the images from at least three different view angles. The components included in the image capture device 300 may not substantially increase an overall volume thereof, and a complicated connection is not required in the image capture device 300 to connect multiple image sensing elements.

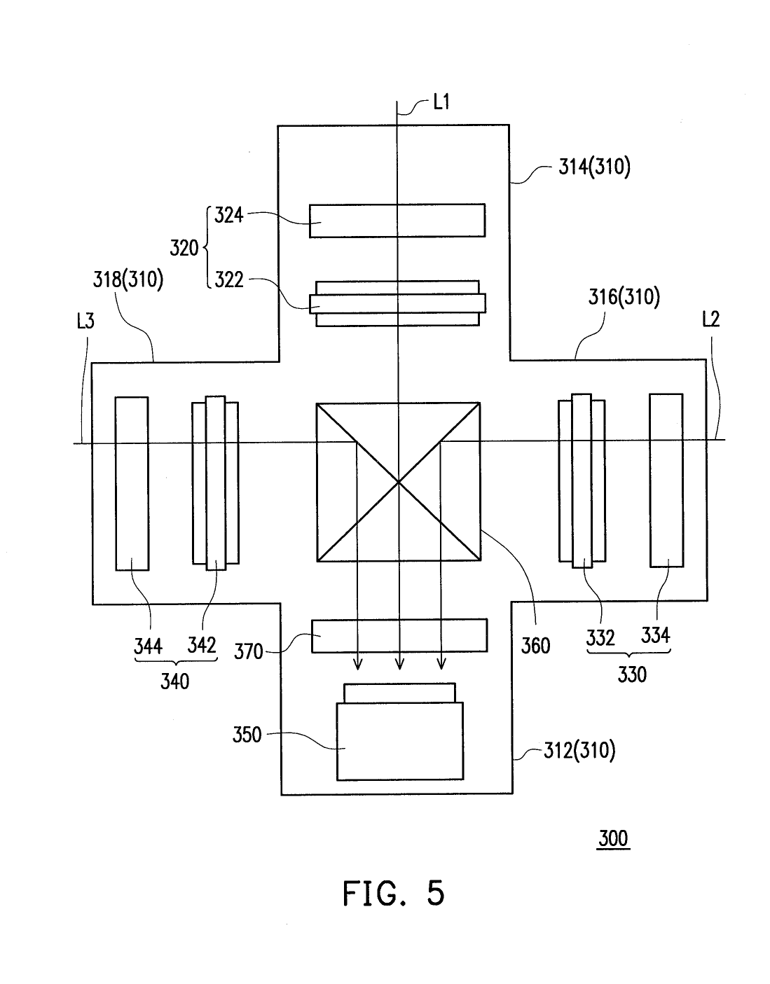

FIG. 6 is a schematic diagram of an image capture device in accordance with a fifth embodiment of the present invention. Referring to FIG. 6, an image capture device 400 includes a housing 410, a first lens unit 420, a second lens unit 430, an image sensing element 440, a beam spliter 450, and a light path adjusting element 460. The housing 410 includes a body 412, a first lens barrel 414, and a second lens barrel 416. The first lens barrel 414 and the second lens barrel 416 are inter-connected with the first body 412. The first lens unit 420 is disposed within the first lens barrel 414 of the housing 410. The second lens unit 430 is disposed within the second lens barrel 416 of the housing 410. The image sensing element 440 is disposed within the body 412 and faces towards the first lens unit 420. The beam spliter 450 is disposed between the first lens unit 420 and the image sensing element 440. Additionally, the light path adjusting element 460 is disposed on a side of the second lens unit 430. The light path adjusting element 460 herein may selectively be a reflector or a prism, wherein the prism may include a triangular prism, pentagonal prism, etc.

In the present embodiment, each of the first lens unit 420 and the second lens unit 430 individually includes a switchable light valve, or individually selectively includes a switchable light valve and at least one lens. The first image light L1 and the second image light L2 may pass into the image capture device 400 alternately through a switch from the switchable light valves. Additionally, the design of the present embodiment may further adjust a passing path of the second image light L2 through an arrangement of the light path adjusting element 460 so that the second image light L2 may be incident onto the beam spliter 450 and pass towards the image sensing element 440 from an effect of the beam spliter 450. That is, although the image sensing element 440 in the present embodiment is disposed correspondingly to, faces towards, the first lens unit 420, the second image light L2 from the second lens unit 430 may also received by the image sensing element 440 from an effect of the components such as the light path adjusting element 460.

Moreover, the first lens barrel 414 and the second lens barrel 416 in the present embodiment mutually overlap in a vertical direction D. That is, the second lens barrel 416 is positioned on a side of the first lens barrel 414 in the vertical direction D. Also, the housing 410 may further include a rotating mechanism 418, wherein the rotating mechanism 418 is disposed between the first lens barrel 414 and the second lens barrel 416. Then, the first lens barrel 414 and the second lens barrel 416 may be rotatively connected to each other because at least one of the first lens barrel 414 and the second lens barrel 416 is suitable to rotate on a plane which is perpendicular to the vertical direction D. Concretely speaking, at least one of the first lens barrel 414 and the second lens barrel 416 is suitable to rotate along a rotating direction R, wherein a plane of the rotating direction R is perpendicular to the vertical direction D.

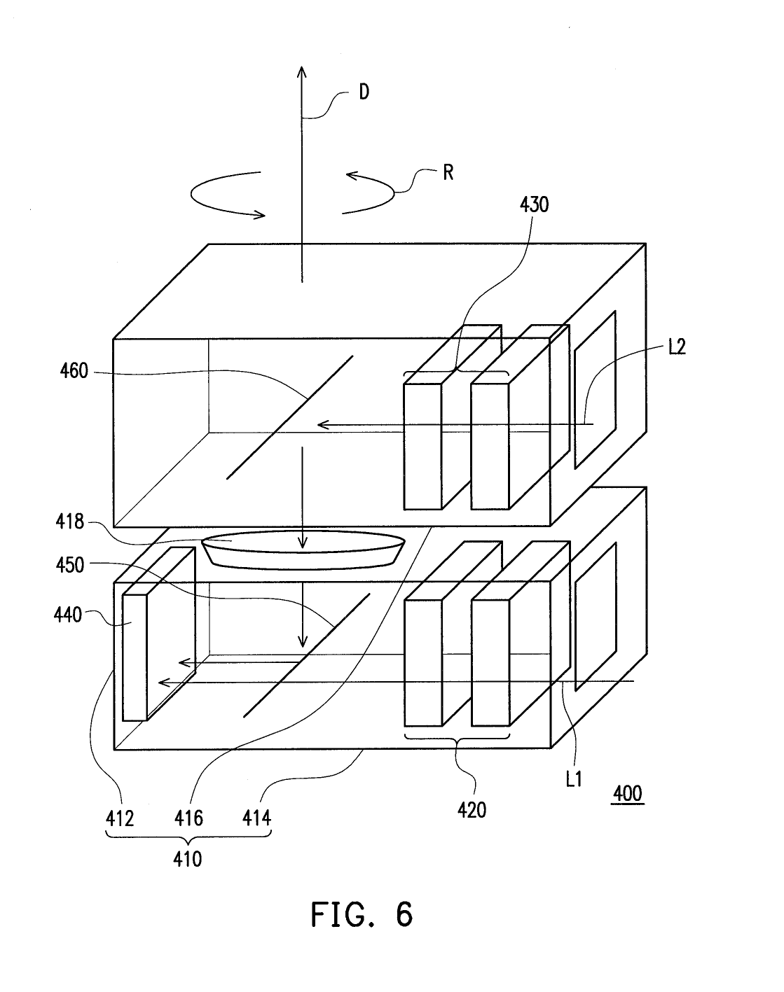

FIG. 7 schematically shows the first lens barrel and the second lens barrel of the image capture device in the fifth embodiment of the present invention after rotation. Referring to both FIG. 6 and FIG. 7, the first lens barrel 414 and the second lens barrel 416 may possess different extended directions after rotation. Meanwhile, the first lens unit 420 and the second lens unit 430 may face towards different directions so as to capture images with different views. Similar to the embodiments as described hereinbefore, since the first image light L1 and the second image light L2 come from different angles, the switchable light valve of the first lens unit 420 and that of the second lens unit 430 may selectively present a transparent state at different timings. Hence, the first image light L1 and the second image light L2 may not be received by the image sensing element 440 simultaneously so as to obtain two different images with high definition.

Since the first lens barrel 414 and the second lens barrel 416 in the present embodiment may rotate freely along the rotating direction R, the extended direction of the first lens barrel 414 and that of the second lens barrel 416 may intersect in multiple different angles or are mutually parallel (as shown in FIG. 6). Hence, a user may adjust the directions of the first lens barrel 414 and the second lens barrel 416 based on different requirements so as to enhance a usage convenience of the image capture device 400.

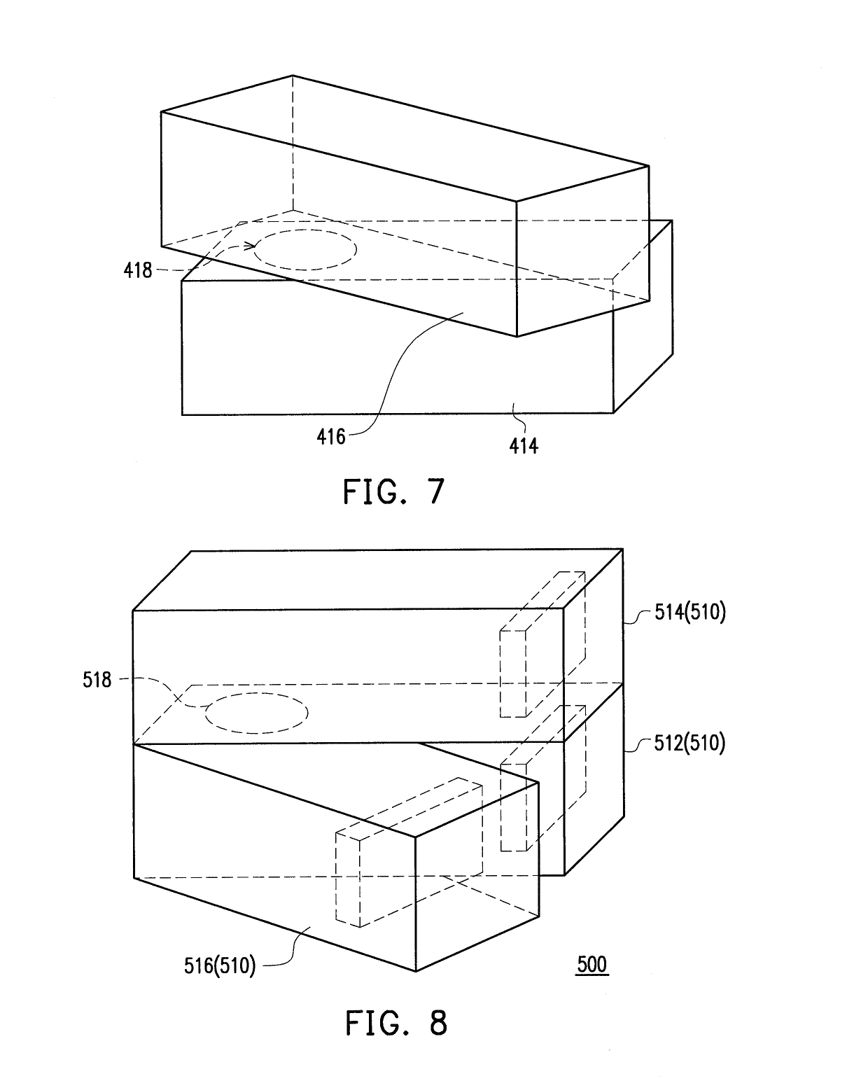

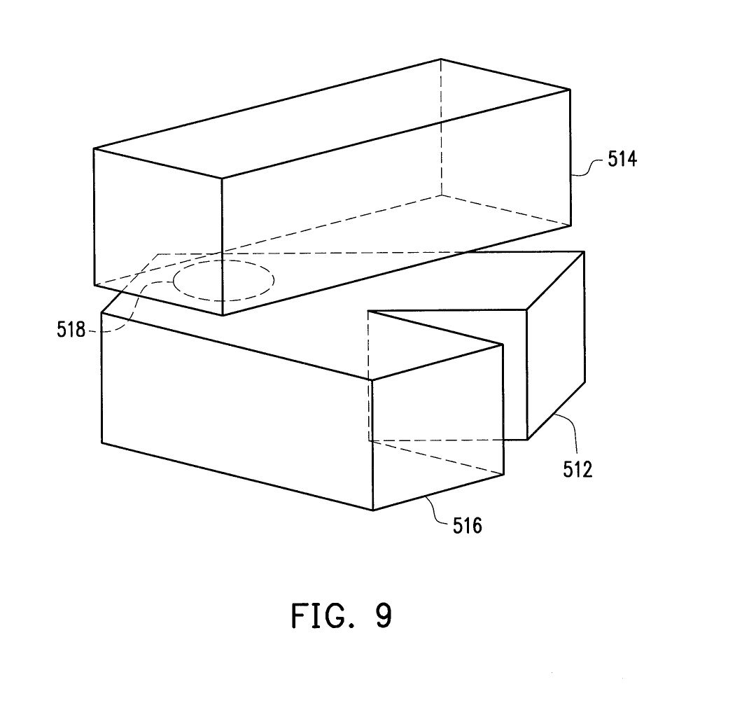

FIG. 8 is a schematic diagram of a housing of an image capture device in accordance with a sixth embodiment of the present invention, and FIG. 9 schematically shows the image capture device in the sixth embodiment of the present invention after rotation of the second lens barrel. Referring to FIG. 8, a housing 510 of an image capture device 500 substantially includes a first lens barrel 512, a second lens barrel 514, and a third lens barrel 516, wherein the second lens barrel 514 and the third lens barrel 516 may substantially disposed on two adjacent sides of the first lens barrel 512. Additionally, the housing 510 may further includes a rotating mechanism 518, wherein the rotating mechanism 518 is disposed between the first lens barrel 512 and the second lens barrel 514. Hence, the second lens barrel 514 is suitable to rotate on a side of the first lens barrel 512.

Concretely speaking, the image capture device 500 in the present embodiment may further include three lens units, which are disposed within the first lens barrel 512, the second lens barrel 514, and the third lens barrel 516 respectively. The image capturing device in the present embodiment may substantially be a combination of the image capture device 200 in FIG. 3A and the image capture device 400 in FIG. 6. Therefore, inner components of the first lens barrel 512 and the third lens barrel 516 disposed within the housing 510 may be substantially referred to the related description of the image capture device 200, and inner components of the second lens barrel 514 may be substantially referred to the related description of the image capture device 400. Hence, only one image sensing element is required to be disposed within the image capture device 500 to capture images from the three lens units.

Since the second lens barrel 514 herein may rotate with respect to the first lens barrel 512 and the third lens barrel 516, referring to FIG. 9, the first lens barrel 512, the second lens barrel 514, and the third lens barrel 516 may possess different extended directions after rotation. That is, the image capture device 500 may capture an image from at least three different angles. Meanwhile, since it is allowed to dispose only one image sensing element in the present embodiment, the volume of the image capture device may not substantially increase, and connections among each component are quite simple. Additionally, the second lens barrel 514 may rotate to different angles based on user requirements so that the image capture device 500 may provide a high usage convenience.

The image capture devices disclosed in the embodiments hereinbefore all include a function of capturing the images from different view angles, and therefore they may be applied to in-vehicle video recorders so as to achieve an image capture effect with multiple view angles with a prerequisite of not overly increasing their volume. Moreover, since the designs of the image capture devices in the embodiments hereinbefore allow the image capture devices possess an image capture effect with multiple view angles, such image capture devices may also be applied in other fields, such as three-dimensional image capturing or holographic image capturing.

To sum up, the image capture devices in the embodiments of the present invention receive image light from different lens units by using one image sensing element so as to simply the volume of the image capture devices. Also, the different lens units in the embodiments of the present invention may face towards to different directions so as to capture an image with different angles and achieve a multi-view image capturing effect. Additionally, a switchable light valve is disposed in each of the multiple lens units in the embodiments of the present invention so that the light is able to pass at different timings. Hence, the same image sensing element may receive images from different lens units at different timings so as to prevent mutual interference among images from different angles. Consequently, the image capture devices in the embodiments of the present invention possess not only a wide-angle image capture effect but also an ideal image quality.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An image capture device comprising
a housing comprising a body, a first lens barrel, and a second lens barrel, wherein the first lens barrel and the second lens barrel are inter-connected with the body;
a first lens unit disposed within the first lens barrel of the housing, wherein the first lens unit comprises a first switchable light valve so as to allow a first image light to pass through the first lens unit;
a second lens unit disposed within the second lens barrel of the housing, wherein the second lens unit comprises a second switchable light valve so as to allow a second image light to pass through the second lens unit;
an image sensing element disposed within the body; and
a beam splitter disposed on at least one of a light path of the first image light and a light path of the second image light so as to allow the image sensing element to receive the first image light and the second image light, wherein the first switchable light valve and the second switchable light valve present a transparent state at different timings.

2. The image capture device of claim 1, wherein the beam splitter is disposed between the first lens unit and the image sensing element.

3. The image capture device of claim 1, wherein the image sensing element faces towards the first lens unit.

4. The image capture device of claim 1, wherein the first lens barrel and the second lens barrel comprise different extended directions so as to allow the first lens unit and the second lens unit to face towards different directions.

5. The image capture device of claim 1, wherein the first lens unit further comprises at least one lens, and the at least one lens is disposed on a side of the first switchable light valve.

6. The image capture device of claim 1, wherein the second lens unit further comprises at least one lens, and wherein the at least one lens is disposed on a side of the second switchable light valve.

7. The image capture device of claim 1, wherein each of the first switchable light valve and the second switchable light valve individually comprises a liquid crystal unit and two polarizers disposed on two opposite sides of the liquid crystal unit.

8. The image capture device of claim 1, wherein the first lens barrel and the second lens barrel mutually overlap in a direction, the housing further comprises a rotating mechanism, and the rotating mechanism is disposed between the first lens barrel and the second lens barrel so as to allow at least one of the first lens barrel and the seconds barrel to suitably rotate on a plane perpendicular to the direction.

9. The image capture device of claim 8, wherein extended directions of the first lens barrel and the second lens barrel are different so as to allow the first lens unit and the second lens unit to face towards different directions.

10. The image capture device of claim 1 further comprising a light path adjusting element disposed on a side of the second lens unit so as to adjust a path of the second image light and allow the second image light to pass towards the beam splitter.

11. The image capture device of claim 10, wherein the light path adjusting element is a reflector or a prism.

12. The image capture device of claim 1 further comprising a third lens unit, wherein the housing further comprises a third lens barrel, the third lens unit is disposed within the third lens barrel, and the third lens unit comprises a third switchable light valve so as to allow a third image light to pass through the third lens unit, and wherein the first switchable light valve, the second switchable light valve, and the third switchable light valve present a transparent state at different timings so as to allow the image sensing element to receive the first image light, the second image light, and the third image light at different timings.

13. The image capture device of claim 12, wherein the third lens unit further comprises at least one lens disposed on a side of the third switchable light valve.

14. The image capture device of claim 12, wherein the third switchable light valve comprises a liquid crystal unit and two polarizers disposed on two opposite sides of the liquid crystal unit.

15. The image capture device of claim 12, wherein each of the first lens barrel, the second lens barrel, and the third lens barrel individually extends to a different direction so as to allow the first lens unit, the second lens unit, and the third lens unit to face towards different directions.

16. The image capture device of claim 12, wherein the second lens barrel and the third lens barrel are substantially disposed on two opposite sides of the first lens barrel.

17. The image capture device of claim 12, wherein the second lens barrel and the third lens barrel are substantially disposed on two adjacent sides of the first lens barrel.

18. The image capture device of claim 17, wherein the housing further comprises a rotating mechanism, and wherein the rotating mechanism is disposed between the first lens barrel and the second lens barrel so as to allow the second lens barrel to suitably rotate on a side of the first lens barrel.
